(19) United States
(12) Patent Application Publication
(10) Pub. No.: US 2026/0099916 A1
(43) Pub. Date: Apr. 9, 2026

(54) IMAGE PROCESSING METHOD, IMAGE PROCESSING APPARATUS, AND LEARNING METHOD

(71) Applicant: Lasertec Corporation, Yokohama (JP)

(72) Inventor: Soya HIROSE, Yokohama-shi (JP)

(21) Appl. No.: 19/349,668

(22) Filed: Oct. 3, 2025

(30) Foreign Application Priority Data
Oct. 4, 2024 (JP) 2024-175149

(51) Int. Cl. G06T 7/00

(52) U.S. Cl. CPC G06T 7/001; G06T 7/0006; G06T 2207/20081; G06T 2207/30148

(57) ABSTRACT

An image processing method includes: a process of acquiring an inspection image, which is an image obtained by imaging an inspection target area of an object to be inspected, the inspection image being included in an image obtained by imaging, by a detector having a predetermined imaging range, the object to be inspected; a process of acquiring positional data indicating an imaging position, which is a position of the inspection image, in the predetermined imaging range; a process of generating a reference image based on design information of the object to be inspected; and a process of inspecting the inspection target area by comparing the inspection image with the reference image, in which in the process of generating the reference image, different reference images are generated, by using the positional data, for areas that show a common structure in the design information.

### INCORPORATION BY REFERENCE

This application is based upon and claims the benefit of priority from Japanese patent application No. 2024-175149, filed on October 04, 2024, the disclosure of which is incorporated herein in its entirety by reference for all purposes.

### BACKGROUND

The present disclosure relates to an image processing method, an image processing apparatus, and a learning method.

One known method for inspecting an object such as a photomask manufactured based on design information is a so-called Die to Database (DDB) inspection in which a captured image of this object is compared with a reference image generated from design information of this object. With regard to this inspection, Patent Literature 1 discloses a technique for generating a reference image using a machine learning model.

[Patent Literature 1] International Patent Publication No. WO 2019/216303

### SUMMARY

The inventors have found that it is possible that a result of imaging an area of an imaging target may change depending on which position in a field of view of imaging means this area is positioned. This is in particular noticeable in an apparatus that uses a critical illumination optical system. It is therefore desired to generate a reference image taking into consideration which in the aforementioned field of view the captured image to be compared with the reference image is positioned. Therefore, a model capable of generating a reference image taking into consideration the above point has been required. Hereinafter, a position in a field of view of imaging means (field-of-view position) will be simply referred to as an imaging position.

The present disclosure has been made in view of the aforementioned circumstances, and provides a novel image processing method and so on capable of contributing to achieving an inspection that uses a reference image taking into consideration an imaging position of a captured image to be compared.

An image processing method according to one aspect of the present disclosure includes: a process of acquiring an inspection image, which is an image obtained by imaging an inspection target area of an object to be inspected, the inspection image being included in an image obtained by imaging, by a detector having a predetermined imaging range, the object to be inspected; a process of acquiring positional data indicating an imaging position, which is a position of the inspection image, in the predetermined imaging range; a process of generating a reference image based on design information of the object to be inspected; and a process of inspecting the inspection target area by comparing the inspection image with the reference image, in which, in the process of generating the reference image, by using the positional data, different reference images are generated for areas that show a common structure in the design information.

In the above image processing method, in the process of generating the reference image, the reference image may be generated by inputting, to a machine learning model that is learned in advance, a design image which is based on the design information and the positional data regarding the inspection image.

In the above image processing method, the machine learning model may be a model that is learned using learning data, which is a set of a learning image included in an image obtained by imaging a learning sample by the detector having the predetermined imaging range, a sample design image, which is an image of the learning sample drawn in accordance with design information of the learning sample, and positional data indicating an imaging position, which is a position of the learning image in the predetermined imaging range.

In the above image processing method, in the process of generating the reference image, a design image which is based on the design information may be corrected, by an optical simulation that uses the positional data regarding the inspection image, to a design image on which the positional data is reflected, and the reference image may be generated by inputting the corrected design image to a machine learning model that is learned in advance.

In the above image processing method, the machine learning model may be a model that is learned using learning data, which is a set of a learning image included in an image obtained by imaging a learning sample by the detector having the predetermined imaging range, and a sample design image, which is an image of the learning sample drawn in accordance with design information of the learning sample.

In the above image processing method, in the process of generating the reference image, the reference image may be generated by inputting a design image which is based on the design information to one of a plurality of machine learning models learned in advance that has been selected based on the positional data regarding the inspection image.

In the above image processing method, each of the plurality of machine learning models may be a model that is learned by using learning data, which is a set of a learning image included in an image obtained by imaging a learning sample by the detector having the predetermined imaging range and a sample design image which is based on design information of the learning sample, and in the learning data used for learning, a section to which an imaging position, which is a position of the learning image in the predetermined imaging range, belongs may be different for each of the machine learning models.

In the above image processing method, a target to be imaged by the detector may be illuminated by critical illumination, the detector may be a TDI sensor that has image pickup elements arranged in a first direction and a second direction and accumulates electrical charges from the plurality of respective image pickup elements arranged in the second direction, and the positional data may indicate an imaging position of the inspection image in the first direction.

In the above image processing method, a positional image, which is a partial image cut out of a gradation image whose width is the same as that of the image captured by the detector, may be used as the positional data, and a relative position of the positional image with respect to the gradation image may correspond to the imaging position of the inspection image.

In the above image processing method, the detector may be a TDI sensor that has image pickup elements arranged in a first direction and a second direction and accumulates electrical charges from the plurality of respective image pickup elements arranged in the second direction, and the gradation image may be an image with gradation in the first direction.

In the above image processing method, a subsequence of a strictly monotonically increasing sequence of numbers or strictly monotonically decreasing sequence of numbers may be used as the positional data, and a relative position of the subsequence with respect to the sequence of numbers may correspond to the imaging position of the inspection image.

In the above image processing method, a subsequence of a weakly monotonically increasing sequence of numbers or weakly monotonically decreasing sequence of numbers may be used as the positional data, the sequence of numbers may successively include a constant value at a center of the sequence of numbers, and a relative position of the subsequence with respect to the sequence of numbers may correspond to the imaging position of the inspection image.

An image processing apparatus according to one aspect of the present disclosure includes: an image acquisition unit configured to acquire an inspection image, which is an image obtained by imaging an inspection target area of an object to be inspected, the inspection image being included in an image obtained by imaging, by a detector having a predetermined imaging range, the object to be inspected; a positional data acquisition unit configured to acquire positional data indicating an imaging position, which is a position of the inspection image, in the predetermined imaging range; a reference image generation unit configured to generate a reference image based on design information of the object to be inspected; and an inspection unit configured to inspect the inspection target area by comparing the inspection image with the reference image, in which the reference image generation unit generates, by using the positional data, different reference images for areas that show a common structure in the design information.

In the above image processing apparatus, the reference image generation unit may generate the reference image by inputting, to a machine learning model that is learned in advance, a design image which is based on the design information and the positional data regarding the inspection image.

In the above image processing apparatus, the machine learning model may be a model that is learned using learning data, which is a set of a learning image included in an image obtained by imaging a learning sample by the detector having the predetermined imaging range, a sample design image, which is an image of the learning sample drawn in accordance with design information of the learning sample, and positional data indicating an imaging position, which is a position of the learning image in the predetermined imaging range.

In the above image processing apparatus, the reference image generation unit may correct, by an optical simulation that uses the positional data regarding the inspection image, a design image which is based on the design information to a design image on which the positional data is reflected, and may generate the reference image by inputting the corrected design image to a machine learning model that is learned in advance.

In the above image processing apparatus, the machine learning model may be a model that is learned using learning data, which is a set of a learning image included in an image obtained by imaging a learning sample by the detector having the predetermined imaging range, and a sample design image, which is an image of the learning sample drawn in accordance with design information of the learning sample.

In the above image processing apparatus, the reference image generation unit may generate the reference image by inputting a design image which is based on the design information to one of a plurality of machine learning models learned in advance that has been selected based on the positional data regarding the inspection image.

In the above image processing apparatus, each of the plurality of machine learning models may be a model that is learned by using learning data, which is a set of a learning image included in an image obtained by imaging a learning sample by the detector having the predetermined imaging range and a sample design image which is based on design information of the learning sample, and in the learning data used for learning, a section to which an imaging position, which is a position of the learning image in the predetermined imaging range, belongs may be different for each of the machine learning models.

In the above image processing apparatus, a target to be imaged by the detector may be illuminated by critical illumination, the detector may be a TDI sensor that has image pickup elements arranged in a first direction and a second direction and accumulates electrical charges from the plurality of respective image pickup elements arranged in the second direction, and the positional data may indicate an imaging position of the inspection image in the first direction.

In the above image processing apparatus, a positional image, which is a partial image cut out of a gradation image whose width is the same as that of the image captured by the detector, may be used as the positional data, and a relative position of the positional image with respect to the gradation image may correspond to the imaging position of the inspection image.

In the above image processing apparatus, the detector may be a TDI sensor that has image pickup elements arranged in a first direction and a second direction and accumulates electrical charges from the plurality of respective image pickup elements arranged in the second direction, and the gradation image may be an image with gradation in the first direction.

In the above image processing apparatus, a subsequence of a strictly monotonically increasing sequence of numbers or strictly monotonically decreasing sequence of numbers may be used as the positional data, and a relative position of the subsequence with respect to the sequence of numbers may correspond to the imaging position of the inspection image.

In the above image processing apparatus, a subsequence of a weakly monotonically increasing sequence of numbers or weakly monotonically decreasing sequence of numbers may be used as the positional data, the sequence of numbers may successively include a constant value at a center of the sequence of numbers, and a relative position of the subsequence with respect to the sequence of numbers may correspond to the imaging position of the inspection image.

A learning method according to one aspect of the present disclosure includes: a process of acquiring learning data, which is a set of a learning image included in an image obtained by imaging a learning sample by a detector having a predetermined imaging range, a sample design image which is based on design information of the learning sample, and positional data indicating an imaging position, which is a position of the learning image in the predetermined imaging range; and a process of generating a machine learning model that receives a target design image and positional data indicating an imaging position, which is a position of an inspection image in the predetermined imaging range, as input and outputs a reference image by performing machine learning by using the learning data, in which the target design image is an image of an inspection target area of an object to be inspected drawn in accordance with design information of an object to be inspected, the inspection image is an image obtained by imaging the inspection target area of the object to be inspected, the inspection image being included in an image obtained by imaging, by the detector, the object to be inspected, and the reference image is an image that is compared with the inspection image in order to inspect the inspection target area.

A learning method according to one aspect of the present disclosure includes: a process of acquiring at least: first learning data, which is a set of a first learning image included in a first section of an image obtained by imaging a learning sample by a detector having a predetermined imaging range, and a sample design image which is based on design information of the learning sample; and second learning data, which is a set of a second learning image included in a second section of the image obtained by imaging the learning sample by the detector, and the sample design image; and a process of generating a first machine learning model that receives a target design image as input and outputs a first reference image by performing machine learning by using the first learning data and generating a second machine learning model that receives the target design image as input and outputs a second reference image by performing machine learning by using the second learning data, in which the target design image is an image of an inspection target area of an object to be inspected drawn in accordance with design information of an object to be inspected, the first reference image and the second reference image are images compared with an inspection image in order to inspect the inspection target area, and the inspection image is an image obtained by imaging the inspection target area of the object to be inspected, the inspection image being included in an image obtained by imaging, by the detector, the object to be inspected.

According to the present disclosure, it is possible to provide a novel image processing method and so on capable of contributing to achieving an inspection that uses a reference image taking into consideration an imaging position of a captured image to be compared.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram showing a configuration of an inspection system according to an embodiment;

FIG. 2 is a block diagram showing one example of a configuration of an image processing apparatus according to the embodiment;

FIG. 3 is a schematic diagram showing a correspondence relationship between an inspection image and positional data;

FIG. 4 is a graph showing an example of a pixel value of a gradation image;

FIG. 5 is a schematic diagram showing generation of a reference image by a reference image generation unit according to a first embodiment;

FIG. 6 is a flowchart showing one example of a flow of an inspection operation in the image processing apparatus according to the embodiment;

FIG. 7 is a schematic diagram showing generation of a reference image by a reference image generation unit according to a second embodiment;

FIG. 8 is a schematic diagram showing generation of a reference image by a reference image generation unit according to a third embodiment;

FIG. 9 is a schematic diagram showing one example of sections of an imaging range of a detector; and

FIG. 10 is a block diagram showing one example of a configuration of a computer that implements processing in the image processing apparatus according to the embodiment.

### DESCRIPTION OF EMBODIMENTS

Hereinafter, with reference to the drawings, specific configurations of embodiments will be described. For the sake of clarification of the description, the following descriptions and the drawings are omitted and simplified as appropriate. In each drawing, the same or corresponding elements have the same reference numerals. Repeated descriptions are omitted as necessary for clarity. Each of the drawings is merely an example for describing one or more embodiments. Each of the drawings is not associated with only one particular embodiment and may instead be associated with one or more other embodiments. Those skilled in the art will appreciate that various features or steps described with reference to any one of the drawings may be combined with features or steps shown in one or more other drawings in order to produce, for example, embodiments that are not explicitly illustrated or described. Not all the features or steps shown in any one of the figures to describe illustrative embodiments are necessary, and some of the features or steps may be omitted. The order of the steps shown in any one of the figures may be changed as appropriate.

### First Embodiment

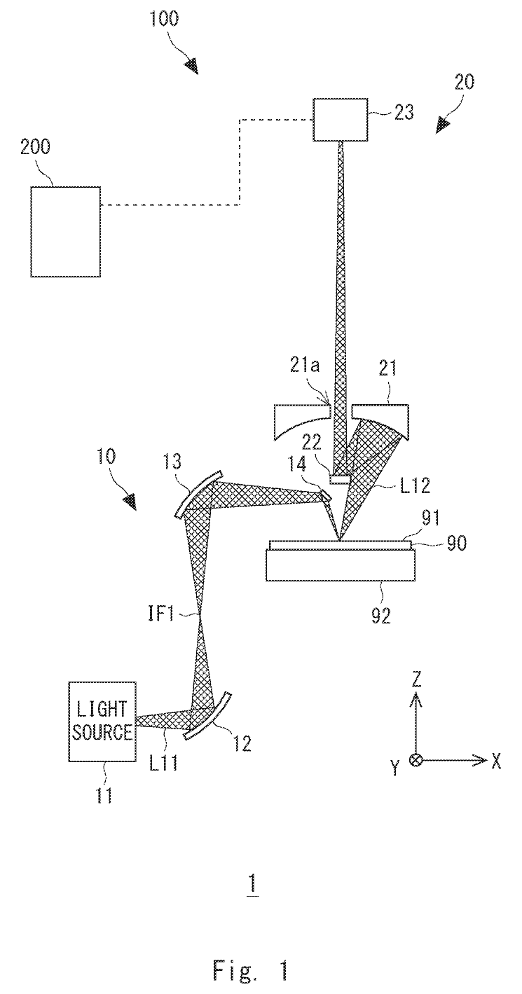

An inspection system according to a first embodiment will be described. FIG. 1 is a schematic diagram showing a configuration of an inspection system according to the embodiment. An inspection system 1 according to this embodiment, which includes an imaging apparatus 100 and an image processing apparatus 200, is used to inspect a sample such as a photomask used in a semiconductor manufacturing process. As shown in FIG. 1, the inspection system 1 is configured as an apparatus for inspecting an object to be inspected by illuminating illumination light onto a sample 90, which is an object to be inspected, and imaging this object to be inspected.

In particular, in this embodiment, the inspection system 1 is used to perform die-to-database inspection. More specifically, the inspection system 1 inspects the object to be inspected by comparing, by the image processing apparatus 200, a reference image generated by the image processing apparatus 200 with a captured image of the object to be inspected captured by the imaging apparatus 100. The reference image is a non-defective image generated based on design information of the object to be inspected.

Hereinafter, the imaging apparatus 100 will be described first, and then the image processing apparatus 200 will be specifically described. Note that the imaging apparatus 100 may be referred to as an optical apparatus.

The sample 90, which is an inspection target of the inspection system 1, is, for example, an Extreme Ultraviolet (EUV) mask, and the imaging apparatus 100 illuminates EUV light onto the sample 90. The sample 90 is not limited to the EUV mask, and may be various kinds of photomasks designed for light having a wavelength longer than that of the EUV light or light having a wavelength shorter than that of the EUV light, or various kinds of members in which fine patterns are formed, such as a semiconductor wafer in which a circuit pattern is formed.

The imaging apparatus 100 includes an illumination optical system 10 and a detection optical system 20. The illumination optical system 10 includes a light source 11, an ellipsoidal mirror 12, an ellipsoidal mirror 13, and a dropping mirror 14. The detection optical system 20 includes a holed concave mirror 21, a convex mirror 22, and a detector 23. The holed concave mirror 21 and the convex mirror 22 form a Schwarzschild magnification optical system.

The light source 11 emits, as illumination light L11, EUV light having a wavelength of 13.5 nm, which is the same wavelength as an exposure wavelength for the EUV mask, i.e., for the sample 90. The illumination light L11 is not limited to the EUV light, and may be light having another wavelength depending on the sample 90. The illumination light L11 emitted from the light source 11 is reflected on the ellipsoidal mirror 12. The illumination light L11 reflected on the ellipsoidal mirror 12 is concentrated at a focal point IF1 positioned in a place conjugate with an upper surface 91 of the sample 90, and is then incident on a reflecting mirror such as the ellipsoidal mirror 13 while spreading.

The illumination light L11 incident on the ellipsoidal mirror 13 is reflected thereon. The illumination light L11 reflected on the ellipsoidal mirror 13 is incident on the dropping mirror 14 while being converged. That is, the ellipsoidal mirror 13 makes the illumination light L11 incident on the dropping mirror 14 as converged light. The dropping mirror 14 is disposed right above the sample 90. The illumination light L11, which has been incident on the dropping mirror 14 and reflected thereon, is incident on the sample 90. That is, the dropping mirror 14 makes the illumination light L11 incident on the sample 90.

The ellipsoidal mirror 13 is designed and disposed so as to concentrate the illumination light L11 onto the sample 90. The illumination optical system 10 is disposed in such a way that an image of the light source 11 (an image of a bright spot) is formed on the upper surface 91 of the sample 90 when the illumination light L11 illuminates the sample 90. Therefore, the illumination optical system 10 provides critical illumination. In this way, the illumination optical system 10 illuminates the inspection target (imaging target) by using the critical illumination by the illumination light L11 generated by the light source 11.

The sample 90 is disposed on a stage 92. Note that a plane parallel to the upper surface 91 of the sample 90 is defined as an XY-plane and a direction perpendicular to the XY plane is defined as a Z direction. The illumination light L11 enters (i.e., incident on) the sample 90 in a direction inclined from the Z direction. That is, the illumination light L11 obliquely enters (i.e., is obliquely incident on) the sample 90 and illuminates the sample 90.

The stage 92 is an XYZ-drive stage. By moving the stage 92 in the XY directions, a desired area on the sample 90 can be illuminated. Further, a focus can be adjusted by moving the stage 92 in the Z direction. The stage 92 may be rotated about at least one of XYZ axes.

The illumination light L11 emitted from the light source 11 illuminates an inspection area on the sample 90. The inspection area illuminated by the illumination light L11 is, for example, an area of 0.5 mm square. The light that has been incident on the sample 90 from the direction inclined from the Z direction and has been obtained from the sample 90 based on the incidence of the illumination light L11, for example, the reflected light L12, is incident on the holed concave mirror 21. A hole 21a is formed at the center of the holed concave mirror 21. While the light obtained from the sample 90 based on the incidence of the illumination light L11 will be referred to as reflected light L12 hereinafter, this light may be diffracted light, scattered light, fluorescence, or the like.

The reflected light L12 reflected on the holed concave mirror 21 is incident on the convex mirror 22. The convex mirror 22 reflects the reflected light L12 coming from the holed concave mirror 21 toward the hole 21a of the holed concave mirror 21. The reflected light L12, which has passed through the hole 21a, is detected by the detector 23. The detector 23, which is a detector that includes a Time Delay Integration (TDI) sensor, acquires image data of the sample 90, which is the inspection target. More specifically, the detector 23 is a TDI sensor that includes image pickup elements arranged in a first direction and a second direction and accumulates electrical charges from the plurality of respective image pickup elements arranged in the second direction. The first direction is, for example, the X direction and the second direction is, for example, the Y direction. This TDI sensor transfers electric charges in the second direction (Y direction), thereby accumulating electrical charges of a row of plurality of image pickup elements that are arranged in the second direction (that is, a plurality of image pickup elements whose positions in the first direction are the same). Accordingly, one-dimensional image data for the first direction is acquired. The detector 23 includes, in the first direction, a plurality of rows of image pickup elements arranged in the second direction, thereby acquiring a plurality of pieces of one-dimensional image data. By coupling the plurality of pieces of one-dimensional image data, two-dimensional image data is generated. The image pickup elements are, for example, but not limited to, Charge Coupled Devices (CCDs).

As described above, the detection optical system 20 concentrates the reflected light L12 from the sample 90 illuminated by the illumination light L11, and acquires image data of the sample 90 by detecting the concentrated reflected light L12 by the detector 23. The plurality of pieces of one-dimensional image data of the sample 90 acquired by the detector 23 are output to the image processing apparatus 200 and processed as two-dimensional image data.

The image processing apparatus 200 is connected to the detection optical system 20 by a wire or wirelessly. The image processing apparatus 200 receives, from the detector 23 in the detection optical system 20, two-dimensional image data formed of a plurality of pieces of one-dimensional image data of the object to be inspected.

Incidentally, the present inventors have found that the imaging result may change depending on which position in the imaging range of the detector 23 an image is captured. This is particularly noticeable in an apparatus that uses a critical illumination optical system. In the imaging range of the detector 23 on the upper surface 91 of the sample 90, it is preferable that the intensity of the illumination light L11 be ideally uniform and constant. However, the intensities of the illumination light in the vicinity of both ends of the imaging range may be lower than those in an area other than the vicinity of both ends (in the vicinity of the center). Therefore, in particular, the imaging result in the vicinity of both ends of the imaging range of the detector 23 and the imaging result in an area other than the vicinity of both ends of the imaging range are different from each other even though the target to be imaged is the same. Further, the imaging result in the vicinity of the right end of the imaging range of the detector 23 and the imaging result in the vicinity of the left end thereof are different from each other. In order to solve this problem, in this embodiment, processing focused on the imaging position is performed by the image processing apparatus 200, thereby reducing the aforementioned influence of the imaging position. It can also be said that the imaging range of the detector 23 is a range of the imaging field of the detector 23. Further, the imaging position means a position in the imaging field of the detector 23 (field-of-view position). Hereinafter, the image processing apparatus 200 will be described.

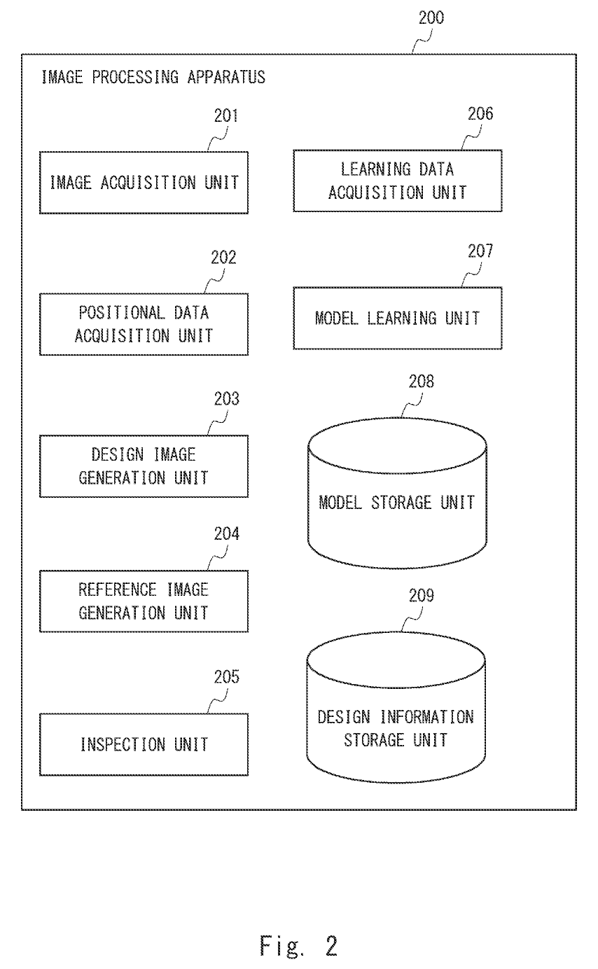

FIG. 2 is a block diagram showing one example of a configuration of the image processing apparatus 200. As shown in FIG. 2, the image processing apparatus 200 includes an image acquisition unit 201, a positional data acquisition unit 202, a design image generation unit 203, a reference image generation unit 204, an inspection unit 205, a learning data acquisition unit 206, a model learning unit 207, a model storage unit 208, and a design information storage unit 209. While the image processing apparatus 200 includes components for generating machine learning models to be used for inspection of the object to be inspected and components that use the machine learning models in the example shown in FIG. 2, the components for generating the machine learning models and the components that use the machine learning models may belong to image processing apparatuses different from each other. The image processing apparatus may be referred to as an inspection apparatus or the like. Further, in particular, an image processing apparatus that includes components for generating the machine learning models may be referred to as a learning apparatus.

The image acquisition unit 201 acquires an inspection image, which is an image obtained by imaging the inspection target area of the object to be inspected. More specifically, the inspection image acquired by the image acquisition unit 201 is an image included in an image obtained by imaging, by the detector 23 having a predetermined imaging range, the object to be inspected. More specifically, it can also be said that the inspection image acquired by the image acquisition unit 201 is a partial image cut out of the image obtained by imaging, by the detector 23 having a predetermined imaging range, the object to be inspected. While images other than the inspection image (e.g., a learning image, a positional image, etc. that will be described later) are also described as a partial image cut out of a specific image in this disclosure, each image thus described is one example of images included in the specific image. In this embodiment, as described above, the inspection image obtained by illuminating, by the critical illumination, the inspection target area of the object to be inspected and imaging the same is acquired. The inspection target area is, for example, a partial area of the surface of the object to be inspected. In this embodiment, the imaging range defined by image pickup elements aligned in the X direction of the detector 23 may correspond to the aforementioned predetermined imaging range. That is, in this embodiment, the imaging range may indicate the imaging range of the detector 23 in the X direction.

The positional data acquisition unit 202 acquires positional data indicating the imaging position of the inspection image acquired by the image acquisition unit 201. This positional data indicates the imaging position of the inspection image in the aforementioned predetermined imaging range. That is, the positional data indicates which position in the predetermined imaging range the acquired inspection image corresponds to. More specifically, the positional data indicates an imaging position of the inspection image in the X direction. In this embodiment, as one example, the positional data acquisition unit 202 acquires a gradation image having pixel values indicating the imaging position as positional data. Therefore, in the following description, the positional data is also referred to as a positional image.

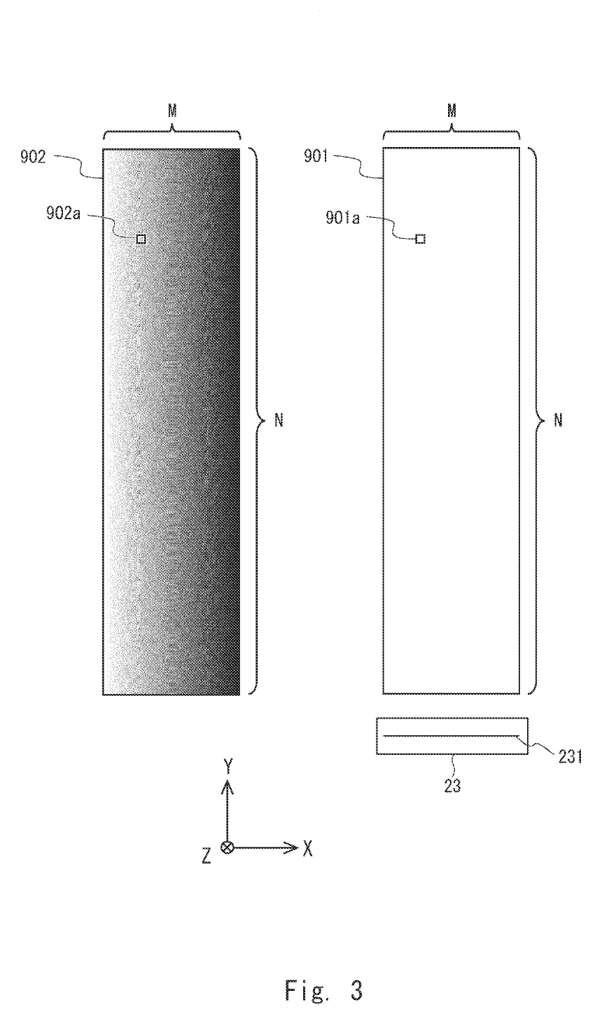

With reference to the drawings, the aforementioned inspection image and positional data, which is an image, will be described. FIG. 3 is a schematic diagram showing a correspondence relationship between the inspection image and the positional data (positional image). FIG. 3 also shows the detector 23, a two-dimensional image 901 obtained by imaging by the detector 23, and a gradation image 902, which is a two-dimensional image to obtain a positional image 902a. The two-dimensional image 901 and the gradation image 902 are two-dimensional images formed of pixels arranged in two orthogonal directions. As shown in FIG. 3, the two-dimensional image 901 can be obtained by performing scanning in the Y direction by a row of image pickup elements 231 aligned in the X direction of the detector 23. More specifically, since the detector 23 is a TDI sensor, as described above, a plurality of rows of image pickup elements 231 are arranged in the Y direction. The two-dimensional image 901, which is an image whose X direction includes M (here M denotes a natural number) pixels and Y direction includes N (here N denotes a natural number) pixels, is a two-dimensional image of the inspection target area. The gradation image 902, which is an image whose X direction includes M pixels and Y direction includes N pixels, is a two-dimensional image with gradation in the X direction. The pixel group arranged in the X direction of the gradation image 902 corresponds to the imaging range of the detector 23 in the X direction. The pixel value of each pixel of the gradation image 902 depends on the position of this pixel in the X direction, and does not depend on the position of this pixel in the Y direction. Therefore, the pixel value of the pixel of the gradation image 902 can indicate the position in the X direction.

As shown in FIG. 3, for example, an inspection image 901a acquired by the image acquisition unit 201, which is a partial image cut out of the two-dimensional image 901, is an image including m (here m denotes a natural number) pixels in the X direction and n (here n denotes a natural number) pixels in the Y direction. Here, m and n are the same as the size of the reference image generated by the reference image generation unit 204 that will be described later. Further, as shown in FIG. 3, for example, the positional image 902a acquired by the positional data acquisition unit 202 is also a partial image cut out of the gradation image 902, and is an image whose X direction includes m pixels and Y direction includes n pixels. Then, as shown in FIG. 3, a relative position of the inspection image 901a with respect to the two-dimensional image 901 is the same as a relative position of the positional image 902a with respect to the gradation image 902. In this embodiment, the image acquisition unit 201 and the positional data acquisition unit 202 acquire the respective images described above. Therefore, the positional image 902a indicates the imaging position of the inspection image 901a. That is, the positional image 902a indicates in which position in the imaging range of the detector 23 in the X direction the inspection image 901a has been captured. While the size of the gradation image 902 in the X direction and that in the Y direction are the same as those of the two-dimensional image 901 in the example shown in FIG. 3, the size of the gradation image 902 in the Y direction may be different from the size of the two-dimensional image 901 in the Y direction. For example, the size of the gradation image 902 in the Y direction may be any size as long as the positional image 902a can be cut out, and the gradation image 902 may be, for example, an image whose Y direction includes n pixels. In this manner, in this embodiment, the positional image, which is a partial image cut out of the gradation image whose width is the same as that of the image captured by the detector 23, is used as the positional data. Further, the relative position of the positional image with respect to the gradation image corresponds to the relative position of the inspection image with respect to the original image of which the inspection image is cut out. That is, the relative position of the positional image with respect to the gradation image corresponds to the imaging position of the inspection image. While the aforementioned gradation image 902 is an image with gradation in only the X direction, it is sufficient that the gradation image 902 have gradation in the X direction, and may have gradation in the Y direction as well.

The positional data (positional image) acquired by the positional data acquisition unit 202 is the image with gradation in the first direction (the X direction). That is, the positional data is data indicating the imaging position in the first direction (the X direction). Further, as described above, the image acquisition unit 201 acquires an inspection image captured by using the detector 23. Then, as described above, the detector 23 is a TDI sensor that accumulates electrical charges from the plurality of respective image pickup elements arranged in the second direction (Y direction). Therefore, in this embodiment, the positional data acquisition unit 202 can acquire appropriate information to take into account a difference in the relative position of the inspection image with respect to the original image of which the inspection image is cut out. This is because, since electrical charges are accumulated by the TDI sensor for the second direction, as described above, the influence of the difference in the relative position of the inspection image with respect to the original image of which the inspection image is cut out is reduced for the second direction. On the other hand, such a reduction cannot be expected for the first direction. Therefore, when the TDI sensor is used as the detector 23, it is preferable to acquire an image with gradation in the first direction (the X direction), that is, to acquire positional data indicating the imaging position in the first direction (the X direction) in order to acquire an appropriate reference image in the reference image generation unit 204 that will be described later.

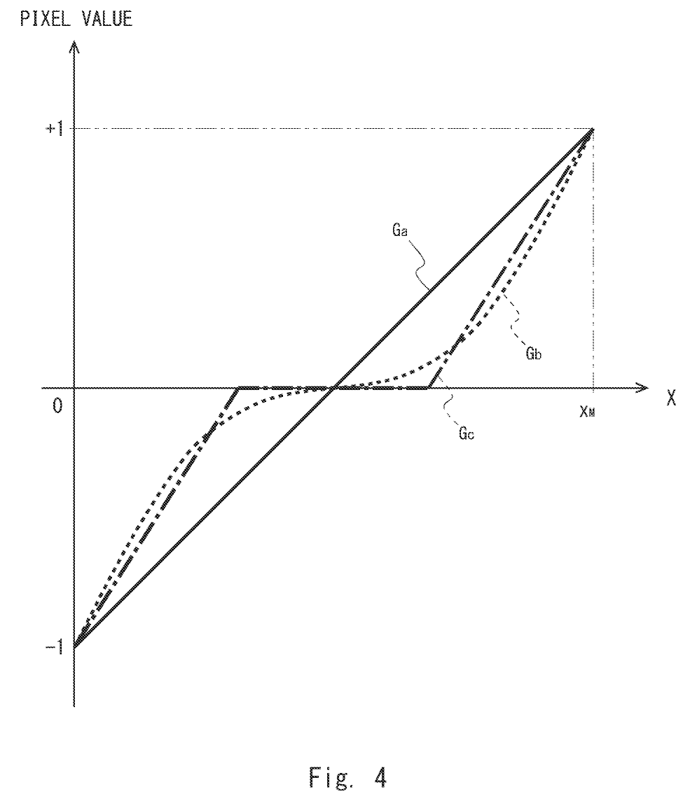

Here, specific examples of the gradation image 902 will be described. In this embodiment, as one example, the value of the pixel at the end of the gradation image 902 in the -X direction is -1, and as the coordinate of the pixel in the X direction becomes greater, the value of the pixel gradually changes from -1 to +1 and the value of the pixel at the end of the gradation image 902 in the +X direction is +1. FIG. 4 is a graph showing an example of the pixel value of the gradation image 902. In the graph shown in FIG. 4, 0 in the X coordinate indicates, for example, the coordinate of the pixel at the left end of the gradation image 902, and corresponds to the left end of the imaging range of the detector 23. Further, XM of the X coordinate indicates, for example, the coordinate of the pixel at the right end of the gradation image 902, and corresponds to the right end of the imaging range of the detector 23. Therefore, specifically, the value of XM is, for example, M. The pixel value of each pixel of the gradation image 902 may be expressed, for example, by a monotonically increasing sequence of numbers whose pixel value changes linearly in accordance with the position of the X direction, as shown by a graph Ga (a solid line graph). This is merely an example, and the pixel value of each pixel of the gradation image 902 may be expressed by a monotonically increasing sequence of numbers whose pixel value changes non-linearly in accordance with the position of the X direction, as shown by a graph Gb (a cubic function graph shown by a dotted line). While the pixel value increases as the coordinate value of the pixel in the X direction becomes greater in each of the graphs Ga and Gb, the pixel value may decrease as the coordinate value of the pixel in the X direction becomes greater. That is, the pixel value of each pixel of the gradation image 902 may be expressed by a monotonically decreasing sequence of numbers whose pixel value changes linearly or non-linearly in accordance with the position of the X direction.

Incidentally, the graphs Ga and Gb each indicate a so-called strictly monotonically increasing sequence of numbers. Here, the strictly monotonically increase means a monotonic increase in which, if x1<x2 is satisfied, p1<p2 is established, where p1 denotes a value of the pixel whose value of the X coordinate is x1 and p2 denotes a value of the pixel whose value of the X coordinate is x2. Likewise, the strictly monotonically decrease means a monotonic decrease in which, if x1<x2 is satisfied, p1>p2 is established. On the other hand, a weakly monotonically increase means a monotonic increase in which, if x1<x2 is satisfied, p1≤p2 is established. Further, a weakly monotonically decrease means a monotonic decrease in which, if x1<x2 is satisfied, p1≥p2 is established. The pixel value of each pixel of the gradation image 902 may be indicated by a strictly monotonically increasing sequence of numbers or strictly monotonically decreasing sequence of numbers, or may be indicated by a weakly monotonically increasing sequence of numbers or weakly monotonically decreasing sequence of numbers. For example, the pixel value of each pixel of the gradation image 902 may be indicated by a weakly monotonically increasing sequence of numbers, like a graph Gc (a dash dotted line graph). In the graph Gc, values of pixels whose positions in the X direction are in the vicinity of the center of the whole are constant, and values of pixels whose positions in the X direction are not in the vicinity of the center monotonically increase in accordance with the position of the X direction. As described above, the influence of the imaging position on the imaging result in the images captured in the vicinity of both ends of the imaging range of the detector 23 is great. In other words, it is not necessarily important in which part of the vicinity of the center of the imaging range of the detector 23 the image captured in the vicinity of the center of the imaging range of the detector has actually been captured. Therefore, like the graph Gc, of the pixel group arranged in the X direction, values of pixels in the vicinity of the center may be constant. While values of pixels other than those in the vicinity of the center of the pixel group arranged in the X direction linearly increase in the graph Gc, it may be increased non-linearly. Further, while the graph Gc indicates a graph of a weakly monotonically increasing sequence of numbers, the pixel value of each pixel of the gradation image 902 may be expressed by a sequence of numbers whose pixel value weakly monotonically decreases in accordance with the position of the X direction.

As will be understood from the aforementioned description, it is not necessarily required that an image be used as positional data, and a subsequence of a strictly monotonically increasing sequence of numbers or strictly monotonically decreasing sequence of numbers (see graph Ga or Gb) may instead be used. Note that a relative position of the subsequence with respect to the sequence of numbers corresponds to a relative position of the inspection image with respect to the original image of which the inspection image is cut out (in particular, relative position in the X direction), that is, the imaging position of the inspection image. Further, as the positional data, a subsequence of a weakly monotonically increasing sequence of numbers or weakly monotonically decreasing sequence of numbers (see graph Gc) that successively includes a constant value at the center thereof may be used. In this case as well, the relative position of the subsequence with respect to the sequence of numbers corresponds to the relative position of the inspection image with respect to the original image of which the inspection image is cut out (in particular, relative position in the X direction), that is, the imaging position of the inspection image. Further, the coordinate value in the X direction indicating the imaging position may be used as the positional data.

The design image generation unit 203 generates a design image, which is an image drawn in accordance with the design information of the object to be inspected. More specifically, the design image generation unit 203 generates a design image for the inspection target area of the object to be inspected (in particular, area corresponding to the inspection image 901a). Specifically, the design image generation unit 203 generates, for example, a design image of m×n pixels in accordance with the design information of the object to be inspected stored in the design information storage unit 209. The design information storage unit 209 stores design information of a desired sample including the object to be inspected. The design information may be, for example, vector data indicating a pattern formed in the sample. For example, the design image generation unit 203 performs rasterization processing based on the design information, and generates a binary image. Then, the design image generation unit 203 pixelates the binary image and generates a gray image having a predetermined number of gradations. This gray image is the design image. While the design image generation unit 203 generates a gray image obtained by pixelating the binary image as the design image in this embodiment, it may generate a binary image as the design image. When, for example, the design information storage unit 209 stores the design image in place of the design information or along with the design information, the image processing apparatus 200 may not include the design image generation unit 203. That is, in this case, the image processing apparatus 200 may use the stored design image, and does not need to generate the design image from the design information. The design information and the design image may be collectively referred to as design information without differentiating between them.

The reference image generation unit 204 generates a reference image from the design image. While the reference image generation unit 204 generates a reference image from the design image generated by the design image generation unit 203 in this embodiment, as described above, the reference image generation unit 204 may not necessarily use the design image generated by the design image generation unit 203 if the reference image can be acquired without generating the design image. The reference image is an image that is compared with the inspection image in order to inspect the inspection target area of the object to be inspected.

In particular, in this embodiment, the reference image generation unit 204 generates, by using the positional data acquired by the positional data acquisition unit 202, reference images different from each other for a first inspection image and a second inspection image, which are inspection images whose imaging positions in a predetermined imaging range are different from each other. That is, when imaging positions in the detector 23 are different from each other even when the design image is the same, the reference image generation unit 204 generates reference images different from each other. That is, when the imaging positions in the detector 23 are different from each other for areas showing a common structure in the design information, the reference image generation unit 204 generates reference images different from each other.

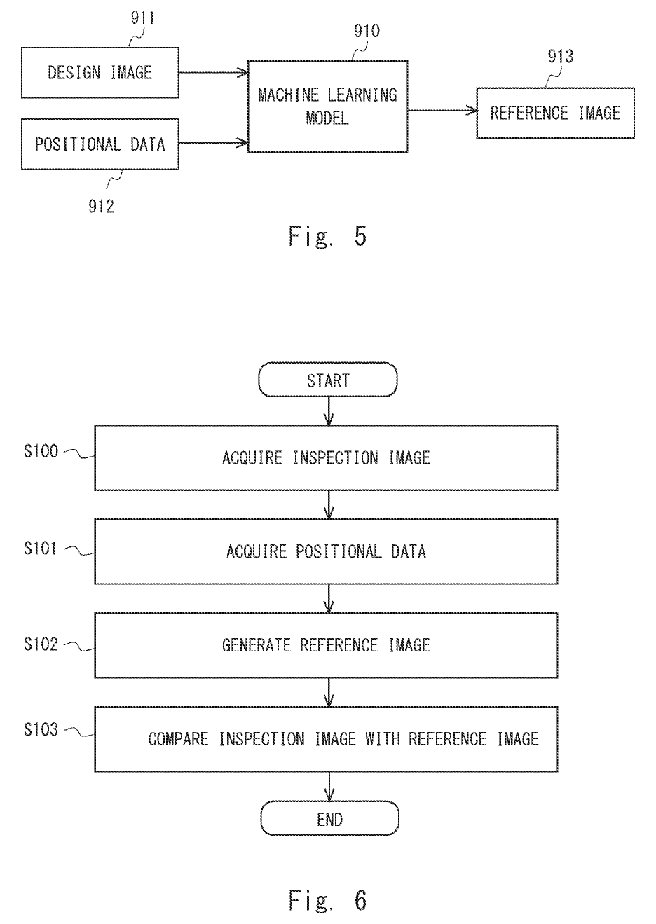

FIG. 5 is a schematic diagram showing generation of the reference image by the reference image generation unit 204 according to this embodiment. As shown in FIG. 5, specifically, in this embodiment, the reference image generation unit 204 generates a reference image 913 by inputting a design image 911, and positional data 912 (positional image) regarding the inspection image to a machine learning model 910 that is learned in advance. That is, the reference image generation unit 204 generates the reference image by using the machine learning model that is learned in advance so as to receive the design image and the positional data indicating the imaging position of the inspection image in a predetermined imaging range as input and output the reference image. It can also be said that this machine learning model 910 is a model in which the influence of properties of the imaging apparatus 100, properties of the process of manufacturing the object to be inspected (e.g., lithography process), or the like on the captured image by the imaging apparatus 100 and the influence of the difference in the imaging position on the captured image are reflected on the image input to the model. Note that the reference image generation unit 204 uses a machine learning model that is learned in advance by the model learning unit 207. The learning of the model by the model learning unit 207 will be described later.

The inspection unit 205 inspects, by comparing the inspection image with the reference image, the presence or absence of an abnormality of the inspection target area of the object to be inspected. The inspection unit 205 compares the inspection image acquired by the image acquisition unit 201 with the reference image generated by the reference image generation unit 204. For example, the inspection unit 205 obtains a difference value of a gradation value (luminance) between the reference image and the inspection image and compares the difference value with a threshold. The inspection unit 205 detects a pattern abnormality, a defect or the like by the result of comparing the difference value with the threshold. That is, the part where the pattern abnormality has occurred is, for example, a part where a foreign matter has adhered, and in this part, the difference value becomes greater than the threshold. The inspection unit 205 outputs an inspection result. The inspection unit 205 outputs, for example, an inspection result indicating the presence or absence of an abnormality. The inspection unit 205 may output information on an abnormal part in association with its position coordinates. The inspection unit 205 may display the inspection result on a display as output, or may transmit the inspection result to another apparatus. Note that the inspection unit 205 may compare images by units of M×N pixels shown in FIG. 3. In this case, the image acquisition unit 201 sequentially cuts out the inspection image 901a from the two-dimensional image 901 (see FIG. 3) of M×N pixels until all the areas of the two-dimensional image 901 are covered. Further, the positional data acquisition unit 202 also sequentially cuts out, of the gradation image 902 (see FIG. 3), the positional image 902a corresponding to the inspection image 901a that is cut out. The design image generation unit 203 further generates a design image for each inspection image 901a. Then, the reference image generation unit 204 generates a reference image for each inspection image 901a. That is, the reference image generation unit 204 repeats, by using the design image corresponding to the inspection image 901a and the positional data (positional image) corresponding to the inspection image 901a, processing for generating a reference image of m×n pixels corresponding to the inspection image 901a. After that, the inspection unit 205 compares the two-dimensional image 901 of M×N pixels with the reference image of M×N pixels formed by connecting the plurality of reference images of m×n pixels.

Next, a flowchart of a flow of an operation of the aforementioned image processing apparatus 200 will be shown. FIG. 6 is a flowchart showing one example of a flow of an inspection operation in the image processing apparatus 200. Hereinafter, with reference to FIG. 6, a flow of an operation for inspecting the object to be inspected will be described.

In Step S100, the image acquisition unit 201 acquires an inspection image of an object to be inspected. Next, in Step S101, the positional data acquisition unit 202 acquires positional data (positional image) indicating an imaging position of the inspection image acquired in Step S100. Next, in Step S102, the reference image generation unit 204 generates a reference image using a design image and positional data. Prior to this step, if necessary, the design image generation unit 203 generates the design image from design information. After Step S102, in Step S103, the inspection unit 205 compares the inspection image with the reference image, thereby inspecting the object to be inspected.

Next, the machine learning model used by the reference image generation unit 204 will be described. In this embodiment, as an example, a deep learning model is used as the machine learning model.

The learning data acquisition unit 206 acquires learning data used for machine learning of a model used by the reference image generation unit 204. The learning data acquisition unit 206 may acquire learning data input from another apparatus, or may acquire learning data by reading out learning data stored in a storage apparatus such as a memory 502, which will be described later, of the image processing apparatus 200. The learning data acquired by the learning data acquisition unit 206 is data formed of a set of a learning image, which is a partial image cut out of the image obtained by imaging the learning sample by a detector having a predetermined imaging range, the sample design image, which is an image of a learning sample drawn in accordance with design information of the learning sample, and positional data indicating the imaging position of a learning image in a predetermined imaging range. The learning sample is, for example, a sample manufactured through a manufacturing process similar to that of the object to be inspected. The learning sample may be a sample in which a pattern used only for learning is formed (that is, a sample whose pattern is different from that of the object to be inspected on which inspection is actually performed) or may be the object to be inspected on which inspection is actually performed.

The learning image is captured by the detector 23. Therefore, the learning data acquisition unit 206 may acquire the learning image via the image acquisition unit 201. Like the inspection image 901a (see FIG. 3), the learning image is, for example, a two-dimensional image of m×n pixels cut out of the two-dimensional image obtained by the detector 23.

Further, in this embodiment, learning positional data is a positional image, and is, for example, a two-dimensional image of m×n pixels cut out of a two-dimensional image (gradation image 902), like the positional image 902a (see FIG. 3). Note that the relative position of the learning image with respect to the original two-dimensional image of which the image is cut out is the same as the relative position of the learning positional image with respect to the original two-dimensional image (gradation image 902) of which the image is cut out.

The sample design image is a design image for an area indicated in the learning image, and is an image generated from design information in a method similar to that when the design image used for the inspection is generated. In this embodiment, specifically, the sample design image is a gray image obtained by pixelating a binary image generated by performing rasterization processing based on the design information. Accordingly, the learning data acquisition unit 206 may acquire a sample design image via the design image generation unit 203. Therefore, the design information storage unit 209 may store design information of the learning sample.

The model learning unit 207 performs machine learning by using the learning data acquired by the learning data acquisition unit 206, thereby generating the machine learning model. Accordingly, the model learning unit 207 generates the machine learning model by performing learning processing by using learning data, which is a set of a learning image, which is a partial image cut out of the image obtained by imaging the learning sample by a detector having a predetermined imaging range, a sample design image, which is an image of the learning sample drawn in accordance with design information of the learning sample, and positional data indicating the imaging position of a learning image in a predetermined imaging range. This machine learning model is a model used by the aforementioned reference image generation unit 204. That is, the machine learning model generated by the model learning unit 207 is a model that receives a design image of the object to be inspected and positional data indicating the imaging position of the inspection image in a predetermined imaging range as input and outputs a reference image. The learned model generated by the machine learning processing of the model learning unit 207 is stored in the model storage unit 208. Then, the reference image generation unit 204 generates a reference image using the learned model stored in the model storage unit 208. That is, the learned model generated by the model learning unit 207 is used as a computer program module for functioning a computer to generate the reference image.

The first embodiment has been described above. In this embodiment, the reference image is generated taking into consideration the imaging position of the inspection image. Therefore, a more appropriate reference image can be generated. It is sufficient that the positional data used in this embodiment indicate the imaging position of the image, and may not necessarily be a positional image cut out of the gradation image.

### Second Embodiment

Next, a second embodiment will be described. A method for generating a reference image using a design image and positional data in this embodiment is different from that in the first embodiment. Hereinafter, a configuration or an operation of the second embodiment that is different from that in the first embodiment will be described, and descriptions that are redundant with those in the first embodiment will be omitted as appropriate.

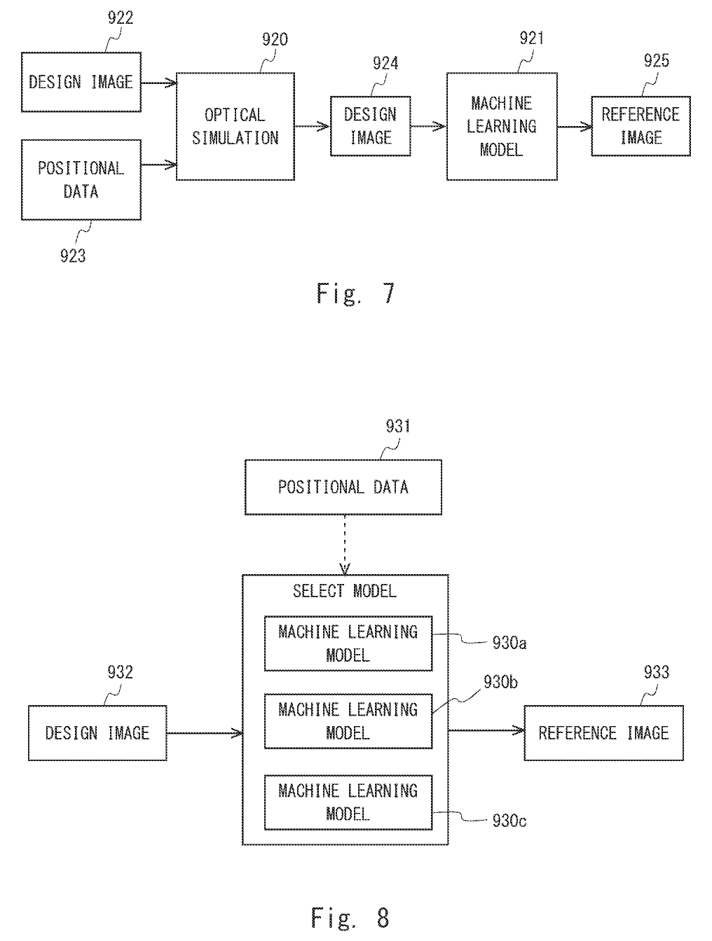

FIG. 7 is a schematic diagram showing generation of a reference image by a reference image generation unit 204 according to the second embodiment. As shown in FIG. 7, in this embodiment, the reference image generation unit 204 corrects, by an optical simulation 920 that uses positional data 923 regarding an inspection image, a design image 922 to a design image 924 on which the positional data 923 is reflected. The design image 922 is an image of an inspection target area drawn in accordance with design information of an object to be inspected, and is, for example, an image generated by the design image generation unit 203. The reference image generation unit 204 generates a reference image 925 by correcting the design image 922 to the design image 924 and then inputting the corrected design image 924 to a machine learning model 921 learned in advance. The optical simulation 920 is a simulator (software) that simulates the captured image corresponding to the design image 922 based on the optical design of the imaging apparatus 100 (the shape or arrangement of a mirror and a lens, lens magnification, or the like) and the positional data, which are parameters. Known software may be used as a simulator that implements the optical simulation 920.

As described above, since the optical simulation 920 using the positional data is performed in this embodiment, the positional data is reflected on the corrected design image 924. Therefore, the machine learning model 921 according to this embodiment does not require positional data as input, unlike the machine learning model that is used in the first embodiment. That is, in this embodiment, the reference image generation unit 204 generates a reference image using a machine learning model that is learned in advance to receive the design image and output the reference image.

The machine learning model 921 according to this embodiment is a model that is learned using learning data formed of a set of the learning image described in the first embodiment and the sample design image described in the first embodiment. The model learning unit 207 according to this embodiment generates the machine learning model 921 using the aforementioned learning data. In this way, in this embodiment, unlike the first embodiment, the machine learning model 921 in which learning has been performed not taking into consideration positional data is used. It can be said that this machine learning model 921 is a model in which the influence of properties of the imaging apparatus 100, properties of the process of manufacturing the object to be inspected (e.g., lithography process), or the like on the captured image by the imaging apparatus 100 is reflected on the image input to the model. As described above, the influence of the difference in the imaging position on the captured image of the imaging apparatus 100 is reflected on the design image 924 by the optical simulation 920. In this embodiment as well, when imaging positions in the detector 23 are different from each other even when the design image is the same, the reference image generation unit 204 generates reference images different from each other.

The second embodiment has been described above. In this embodiment as well, the reference image is generated taking into consideration the imaging position of the inspection image. Therefore, a more appropriate reference image can be generated. In this embodiment as well, it is sufficient that the positional data indicate the imaging position of the image, and may not necessarily be a positional image cut out of the gradation image.

### Third Embodiment

Next, a third embodiment will be described. In this embodiment as well, a method for generating a reference image using a design image and positional data is different from that in the first embodiment. Here, a configuration or an operation that is different from that in the first embodiment will be described, and descriptions that are redundant with those in the first embodiment will be omitted as appropriate.

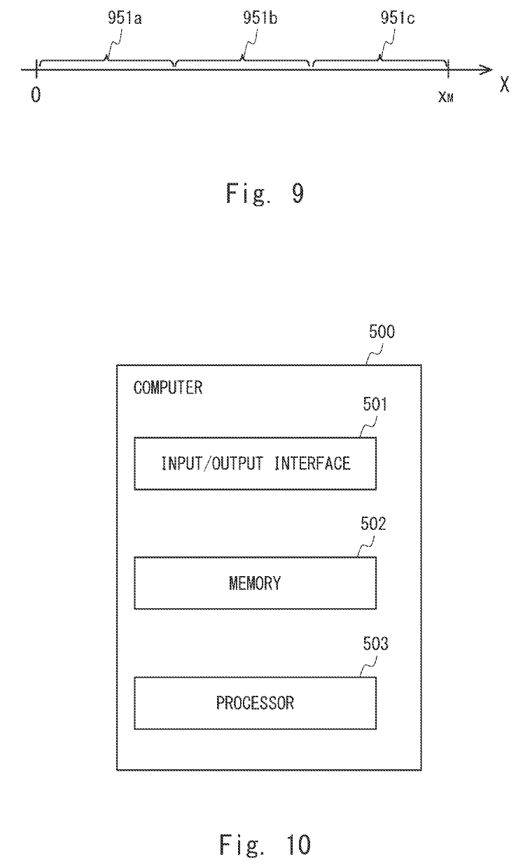

FIG. 8 is a schematic diagram showing generation of a reference image by the reference image generation unit 204 according to the third embodiment. As shown in FIG. 8, in this embodiment, the reference image generation unit 204 generates a reference image 933 by inputting a design image 932 to one of a plurality of machine learning models learned in advance that has been selected based on positional data 931 for an inspection image. In this embodiment, as one example, the reference image generation unit 204 selectively uses three machine learning models 930a, 930b, and 930c based on the positional data 931. Hereinafter, with reference to FIG. 9, selective use of the models based on the positional data 931 will be specifically described.

FIG. 9 is a schematic diagram showing one example of sections of an imaging range of the detector 23. In FIG. 9, 0 in the X coordinate corresponds to, for example, the left end of the imaging range of the detector 23, and XM in the X coordinate corresponds to, for example, the right end of the imaging range of the detector 23. Therefore, specifically, the value of XM is, for example, M. In this embodiment, the imaging range of the detector 23 is classified into three sections. In the example shown in FIG. 9, for example, a first section 951a of the imaging range is a predetermined partial imaging range in the vicinity of the left end of the imaging range of the detector 23, a second section 951b of the imaging range is a predetermined partial imaging range in the vicinity of the center of the imaging range of the detector 23, and a third section 951c of the imaging range is a predetermined partial imaging range in the vicinity of the right end of the imaging range of the detector 23.

In this embodiment, the machine learning model 930a shown in FIG. 8 is a model that is used when the imaging position indicated by the positional data 931 used to generate the reference image belongs to the aforementioned first section 951a. Likewise, the machine learning model 930b is a model that is used when the imaging position indicated by the positional data 931 used to generate the reference image belongs to the aforementioned second section 951b, and the machine learning model 930c is a model that is used when the imaging position indicated by the positional data 931 used to generate the reference image belongs to the aforementioned third section 951c.

The machine learning model 930a is a model that is learned in advance using first learning data, which is a set of a first learning image, which is a partial image cut out of the first section of the image obtained by imaging the learning sample by the detector 23 having a predetermined imaging range, and a sample design image, which is an image of the learning sample drawn in accordance with design information of the learning sample. Here, the aforementioned "partial image cut out of the first section" is, for example, a partial image in which the imaging position belongs to the first section 951a in the predetermined imaging range. Further, the machine learning model 930b is a model that is learned in advance using second learning data, which is a set of a second learning image, which is a partial image cut out of the second section of the image obtained by imaging the learning sample by the detector 23 having a predetermined imaging range, and a sample design image, which is an image of the learning sample drawn in accordance with design information of the learning sample. Here, the aforementioned "partial image cut out of the second section" is, for example, a partial image in which the imaging position belongs to the second section 951b in the predetermined imaging range. Likewise, the machine learning model 930c is a model that is learned in advance using third learning data, which is a set of a third learning image, which is a partial image cut out of the third section of the image obtained by imaging the learning sample by the detector 23 having a predetermined imaging range, and a sample design image, which is an image of the learning sample drawn in accordance with design information of the learning sample. Here, the aforementioned "partial image cut out of the third section" is, for example, a partial image in which the imaging position belongs to the third section 951c in the predetermined imaging range. Therefore, in this embodiment, the learning data acquisition unit 206 acquires the first learning data, the second learning data, and the third learning data. Then the model learning unit 207 generates the machine learning model 930a which receives the design image as input and outputs the first reference image by performing machine learning by using the first learning data. Likewise, the model learning unit 207 generates the machine learning model 930b which receives the design image as input and outputs the second reference image by performing machine learning using the second learning data, and generates the machine learning model 930c which receives the design image as input and outputs the third reference image by performing machine learning using the third learning data.

In this way, in this embodiment, each of the plurality of machine learning models is a model that has been learned using learning data, which is a set of a learning image, which is a partial image cut out of the image obtained by imaging the learning sample by a detector having a predetermined imaging range, and a sample design image, which is an image of the learning sample drawn in accordance with design information of the learning sample. However, in the learning data used for learning, a section to which the imaging position of the learning image in the predetermined imaging range belongs is different for each of the machine learning models. While three models are selectively used in this embodiment, it is sufficient that the reference image generation unit 204 selectively use at least two models.

The reference image generation unit 204 generates a reference image by using one of the machine learning models thus generated in advance that has been selected according to positional data (that is, imaging position). The reference image generation unit 204 determines which one of the aforementioned three sections the positional data 931 acquired by the positional data acquisition unit 202 to generate the reference image belongs to. Then the reference image generation unit 204 generates a reference image by using one of the machine learning models 930a to 930c that corresponds to the determined section. In this embodiment as well, when imaging positions in the detector 23 are different from each other even when the design image is the same, the reference image generation unit 204 generates reference images different from each other.

The third embodiment has been described above. In this embodiment as well, the reference image is generated taking into consideration the imaging position of the inspection image. Therefore, a more appropriate reference image can be generated. In this embodiment as well, it is sufficient that the positional data indicate the imaging position of the image, and may not necessarily be a positional image cut out of the gradation image.

While the embodiments have been described above, the aforementioned function (processing) of the image processing apparatus 200 may be implemented, for example, by a computer 500 having the following configurations.

FIG. 10 is a block diagram showing one example of a configuration of the computer 500 that implements processing in the image processing apparatus 200. As shown in FIG. 10, the computer 500 includes an input/output interface 501, a memory 502, and a processor 503.

The input/output interface 501 is an interface for connecting to another apparatus (e.g., the imaging apparatus 100).

The memory 502 is formed of, for example, a combination of a volatile memory with a non-volatile memory. The memory 502 is used to store software (computer program) including one or more instructions executed by the processor 503, and data or the like used for various kinds of processing. The model storage unit 208 and the design information storage unit 209 may be implemented, for example, by the memory 502, but may be implemented by a desired storage apparatus other than the memory 502.

The processor 503 loads the software (computer program) from the memory 502 and executes the loaded software (computer program), thereby performing the aforementioned processing of the image processing apparatus 200. The processor 503 may be, for example, a microprocessor, a Micro Processor Unit (MPU), a Central Processing Unit (CPU), a Graphics Processing Unit (GPU), or the like. The processor 503 may include a plurality of processors.

The program is included in a computer program product.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Further, the present disclosure is not limited to the aforementioned embodiments and may be changed as appropriate without departing from the spirit of the present disclosure.

Further, the whole or part of the embodiments disclosed above can be described as, but not limited to, the following supplementary notes.

### Supplementary Note 1

An image processing method comprising: a process of acquiring an inspection image, which is an image obtained by imaging an inspection target area of an object to be inspected, the inspection image being included in an image obtained by imaging, by a detector having a predetermined imaging range, the object to be inspected; a process of acquiring positional data indicating an imaging position, which is a position of the inspection image, in the predetermined imaging range; a process of generating a reference image based on design information of the object to be inspected; and a process of inspecting the inspection target area by comparing the inspection image with the reference image, wherein, in the process of generating the reference image, by using the positional data, different reference images are generated for areas that show a common structure in the design information.

### Supplementary Note 2

The image processing method according to Supplementary Note 1, wherein, in the process of generating the reference image, the reference image is generated by inputting, to a machine learning model that is learned in advance, a design image which is based on the design information and the positional data regarding the inspection image.

### Supplementary Note 3

The image processing method according to Supplementary Note 2, wherein the machine learning model is a model that is learned using learning data, which is a set of a learning image included in an image obtained by imaging a learning sample by the detector having the predetermined imaging range, a sample design image, which is an image of the learning sample drawn in accordance with design information of the learning sample, and positional data indicating an imaging position, which is a position of the learning image in the predetermined imaging range.

### Supplementary Note 4

The image processing method according to Supplementary Note 1, wherein in the process of generating the reference image, a design image which is based on the design information is corrected, by an optical simulation that uses the positional data regarding the inspection image, to a design image on which the positional data is reflected, and the reference image is generated by inputting the corrected design image to a machine learning model that is learned in advance.

### Supplementary Note 5

The image processing method according to Supplementary Note 4, wherein the machine learning model is a model that is learned using learning data, which is a set of a learning image included in an image obtained by imaging a learning sample by the detector having the predetermined imaging range, and a sample design image, which is an image of the learning sample drawn in accordance with design information of the learning sample.

### Supplementary Note 6

The image processing method according to Supplementary Note 1, wherein, in the process of generating the reference image, the reference image is generated by inputting a design image which is based on the design information to one of a plurality of machine learning models learned in advance that has been selected based on the positional data regarding the inspection image.

### Supplementary Note 7

The image processing method according to Supplementary Note 6, wherein each of the plurality of machine learning models is a model that is learned by using learning data, which is a set of a learning image included in an image obtained by imaging a learning sample by the detector having the predetermined imaging range and a sample design image which is based on design information of the learning sample, and in the learning data used for learning, a section to which an imaging position, which is a position of the learning image in the predetermined imaging range, belongs is different for each of the machine learning models.

### Supplementary Note 8

The image processing method according to any one of Supplementary Notes 1 to 7, wherein a target to be imaged by the detector is illuminated by critical illumination, the detector is a TDI sensor that has image pickup elements arranged in a first direction and a second direction and accumulates electrical charges from the plurality of respective image pickup elements arranged in the second direction, and the positional data indicates an imaging position of the inspection image in the first direction.

### Supplementary Note 9

The image processing method according to any one of Supplementary Notes 1 to 8, wherein a positional image, which is a partial image cut out of a gradation image whose width is the same as that of the image captured by the detector, is used as the positional data, and a relative position of the positional image with respect to the gradation image corresponds to the imaging position of the inspection image.

### Supplementary Note 10

The image processing method according to Supplementary Note 9, wherein the detector is a TDI sensor that has image pickup elements arranged in a first direction and a second direction and accumulates electrical charges from the plurality of respective image pickup elements arranged in the second direction, and the gradation image is an image with gradation in the first direction.

### Supplementary Note 11

The image processing method according to any one of Supplementary Notes 1 to 10, wherein a subsequence of a strictly monotonically increasing sequence of numbers or strictly monotonically decreasing sequence of numbers is used as the positional data, and a relative position of the subsequence with respect to the sequence of numbers corresponds to the imaging position of the inspection image.

### Supplementary Note 12

The image processing method according to any one of Supplementary Notes 1 to 10, wherein a subsequence of a weakly monotonically increasing sequence of numbers or weakly monotonically decreasing sequence of numbers is used as the positional data, the sequence of numbers successively includes a constant value at a center of the sequence of numbers, and a relative position of the subsequence with respect to the sequence of numbers corresponds to the imaging position of the inspection image.

### Supplementary Note 13

An image processing apparatus comprising: an image acquisition unit configured to acquire an inspection image, which is an image obtained by imaging an inspection target area of an object to be inspected, the inspection image being included in an image obtained by imaging, by a detector having a predetermined imaging range, the object to be inspected; a positional data acquisition unit configured to acquire positional data indicating an imaging position, which is a position of the inspection image, in the predetermined imaging range; a reference image generation unit configured to generate a reference image based on design information of the object to be inspected; and an inspection unit configured to inspect the inspection target area by comparing the inspection image with the reference image, wherein the reference image generation unit generates, by using the positional data, different reference images for areas that show a common structure in the design information.

### Supplementary Note 14

The image processing apparatus according to Supplementary Note 13, wherein the reference image generation unit generates the reference image by inputting, to a machine learning model that is learned in advance, a design image which is based on the design information and the positional data regarding the inspection image.

### Supplementary Note 15

The image processing apparatus according to Supplementary Note 14, wherein the machine learning model is a model that is learned using learning data, which is a set of a learning image included in an image obtained by imaging a learning sample by the detector having the predetermined imaging range, a sample design image, which is an image of the learning sample drawn in accordance with design information of the learning sample, and positional data indicating an imaging position, which is a position of the learning image in the predetermined imaging range.

### Supplementary Note 16

The image processing apparatus according to Supplementary Note 13, wherein the reference image generation unit corrects, by an optical simulation that uses the positional data regarding the inspection image, a design image which is based on the design information to a design image on which the positional data is reflected, and the reference image generation unit generates the reference image by inputting the corrected design image to a machine learning model that is learned in advance.

### Supplementary Note 17

The image processing apparatus according to Supplementary Note 16, wherein the machine learning model is a model that is learned using learning data, which is a set of a learning image included in an image obtained by imaging a learning sample by the detector having the predetermined imaging range, and a sample design image, which is an image of the learning sample drawn in accordance with design information of the learning sample.

### Supplementary Note 18

The image processing apparatus according to Supplementary Note 13, wherein the reference image generation unit generates the reference image by inputting a design image which is based on the design information to one of a plurality of machine learning models learned in advance that has been selected based on the positional data regarding the inspection image.

### Supplementary Note 19

The image processing apparatus according to Supplementary Note 18, wherein each of the plurality of machine learning models is a model that is learned by using learning data, which is a set of a learning image included in an image obtained by imaging a learning sample by the detector having the predetermined imaging range and a sample design image which is based on design information of the learning sample, and in the learning data used for learning, a section to which an imaging position, which is a position of the learning image in the predetermined imaging range, belongs is different for each of the machine learning models.

### Supplementary Note 20

The image processing apparatus according to any one of Supplementary Notes 13 to 19, wherein a target to be imaged by the detector is illuminated by critical illumination, the detector is a TDI sensor that has image pickup elements arranged in a first direction and a second direction and accumulates electrical charges from the plurality of respective image pickup elements arranged in the second direction, and the positional data indicates an imaging position of the inspection image in the first direction.

### Supplementary Note 21

The image processing apparatus according to any one of Supplementary Notes 13 to 20, wherein a positional image, which is a partial image cut out of a gradation image whose width is the same as that of the image captured by the detector, is used as the positional data, and a relative position of the positional image with respect to the gradation image corresponds to the imaging position of the inspection image.

### Supplementary Note 22

The image processing apparatus according to Supplementary Note 21, wherein the detector is a TDI sensor that has image pickup elements arranged in a first direction and a second direction and accumulates electrical charges from the plurality of respective image pickup elements arranged in the second direction, and the gradation image is an image with gradation in the first direction.

### Supplementary Note 23

The image processing apparatus according to any one of Supplementary Notes 13 to 22, wherein a subsequence of a strictly monotonically increasing sequence of numbers or strictly monotonically decreasing sequence of numbers is used as the positional data, and a relative position of the subsequence with respect to the sequence of numbers corresponds to the imaging position of the inspection image.

### Supplementary Note 24

The image processing apparatus according to any one of Supplementary Notes 13 to 22, wherein a subsequence of a weakly monotonically increasing sequence of numbers or weakly monotonically decreasing sequence of numbers is used as the positional data, the sequence of numbers successively includes a constant value at a center of the sequence of numbers, and a relative position of the subsequence with respect to the sequence of numbers corresponds to the imaging position of the inspection image.

### Supplementary Note 25

A learning method comprising: a process of acquiring learning data, which is a set of a learning image included in an image obtained by imaging a learning sample by a detector having a predetermined imaging range, a sample design image which is based on design information of the learning sample, and positional data indicating an imaging position, which is a position of the learning image in the predetermined imaging range; and a process of generating a machine learning model that receives a target design image and positional data indicating an imaging position, which is a position of an inspection image in the predetermined imaging range, as input and outputs a reference image by performing machine learning by using the learning data, wherein the target design image is an image of an inspection target area of an object to be inspected drawn in accordance with design information of an object to be inspected, the inspection image is an image obtained by imaging the inspection target area of the object to be inspected, the inspection image being included in an image obtained by imaging, by the detector, the object to be inspected, and the reference image is an image that is compared with the inspection image in order to inspect the inspection target area.

### Supplementary Note 26

A learning method comprising: a process of acquiring at least: first learning data, which is a set of a first learning image included in a first section of an image obtained by imaging a learning sample by a detector having a predetermined imaging range, and a sample design image which is based on design information of the learning sample; and second learning data, which is a set of a second learning image included in a second section of the image obtained by imaging the learning sample by the detector, and the sample design image; and a process of generating a first machine learning model that receives a target design image as input and outputs a first reference image by performing machine learning by using the first learning data and generating a second machine learning model that receives the target design image as input and outputs a second reference image by performing machine learning by using the second learning data, wherein the target design image is an image of an inspection target area of an object to be inspected drawn in accordance with design information of an object to be inspected, the first reference image and the second reference image are images compared with an inspection image in order to inspect the inspection target area, and the inspection image is an image obtained by imaging the inspection target area of the object to be inspected, the inspection image being included in an image obtained by imaging, by the detector, the object to be inspected.

### Supplementary Note 27

A program for causing a computer to execute: a step of acquiring an inspection image, which is an image obtained by imaging an inspection target area of an object to be inspected, the inspection image being included in an image obtained by imaging, by a detector having a predetermined imaging range, the object to be inspected; a step of acquiring positional data indicating an imaging position, which is a position of the inspection image, in the predetermined imaging range; a step of generating a reference image based on design information of the object to be inspected; and a step of inspecting the inspection target area by comparing the inspection image with the reference image, wherein, in the step of generating the reference image, the reference images different from each other are generated, by using the positional data, for areas that show a common structure in the design information.

### Supplementary Note 28

The program according to Supplementary Note 27, wherein, in the step of generating the reference image, the reference image is generated by inputting, to a machine learning model that is learned in advance, a design image which is based on the design information and the positional data regarding the inspection image.

### Supplementary Note 29

The program according to Supplementary Note 28, wherein the machine learning model is a model that is learned using learning data, which is a set of a learning image included in an image obtained by imaging a learning sample by the detector having the predetermined imaging range, a sample design image, which is an image of the learning sample drawn in accordance with design information of the learning sample, and positional data indicating an imaging position, which is a position of the learning image in the predetermined imaging range.

### Supplementary Note 30

The program according to Supplementary Note 27, wherein, in the step of generating the reference image, a design image which is based on the design information is corrected, by an optical simulation that uses the positional data regarding the inspection image, to a design image on which the positional data is reflected, and the reference image is generated by inputting the corrected design image to a machine learning model that is learned in advance.

### Supplementary Note 31

The program according to Supplementary Note 30, wherein the machine learning model is a model that is learned using learning data, which is a set of a learning image included in an image obtained by imaging a learning sample by the detector having the predetermined imaging range, and a sample design image, which is an image of the learning sample drawn in accordance with design information of the learning sample.

### Supplementary Note 32

The program according to Supplementary Note 27, wherein, in the step of generating the reference image, the reference image is generated by inputting a design image which is based on the design information to one of a plurality of machine learning models learned in advance that has been selected based on the positional data regarding the inspection image.

### Supplementary Note 33

The program according to Supplementary Note 32, wherein each of the plurality of machine learning models is a model that is learned by using learning data, which is a set of a learning image included in an image obtained by imaging a learning sample by the detector having the predetermined imaging range and a sample design image which is based on design information of the learning sample, and in the learning data used for learning, a section to which an imaging position, which is a position of the learning image in the predetermined imaging range, belongs is different for each of the machine learning models.

### Supplementary Note 34

The program according to any one of Supplementary Notes 27 to 33, wherein a target to be imaged by the detector is illuminated by critical illumination, the detector is a TDI sensor that has image pickup elements arranged in a first direction and a second direction and accumulates electrical charges from the plurality of respective image pickup elements arranged in the second direction, and the positional data indicates an imaging position of the inspection image in the first direction.

### Supplementary Note 35

The program according to any one of Supplementary Notes 27 to 34, wherein a positional image, which is a partial image cut out of a gradation image whose width is the same as that of the image captured by the detector, is used as the positional data, and a relative position of the positional image with respect to the gradation image corresponds to the imaging position of the inspection image.

### Supplementary Note 36

The program according to Supplementary Note 35, wherein the detector is a TDI sensor that has image pickup elements arranged in a first direction and a second direction and accumulates electrical charges from the plurality of respective image pickup elements arranged in the second direction, and the gradation image is an image with gradation in the first direction.

### Supplementary Note 37

The program according to any one of Supplementary Notes 27 to 36, wherein a subsequence of a strictly monotonically increasing sequence of numbers or strictly monotonically decreasing sequence of numbers is used as the positional data, and a relative position of the subsequence with respect to the sequence of numbers corresponds to the imaging position of the inspection image.

### Supplementary Note 38

The program according to any one of Supplementary Notes 27 to 36, wherein a subsequence of a weakly monotonically increasing sequence of numbers or weakly monotonically decreasing sequence of numbers is used as the positional data, the sequence of numbers successively includes a constant value at a center of the sequence of numbers, and a relative position of the subsequence with respect to the sequence of numbers corresponds to the imaging position of the inspection image.

### Supplementary Note 39

An image processing method comprising: a process of acquiring an inspection image, which is an image obtained by imaging an inspection target area of an object to be inspected, the inspection image being included in an image obtained by imaging, by a detector having a predetermined imaging range, the object to be inspected; a process of acquiring positional data indicating an imaging position, which is a position of the inspection image, in the predetermined imaging range; a process of generating a reference image based on design information of the object to be inspected; and a process of inspecting the inspection target area by comparing the inspection image with the reference image, wherein in the process of generating the reference image, different reference images are generated, by using the positional data, for a first inspection image and a second inspection image, which are inspection images whose imaging positions in the predetermined imaging range are different from each other. The first to third embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An image processing method comprising:
a process of acquiring an inspection image, which is an image obtained by imaging an inspection target area of an object to be inspected, the inspection image being included in an image obtained by imaging, by a detector having a predetermined imaging range, the object to be inspected;
a process of acquiring positional data indicating an imaging position, which is a position of the inspection image, in the predetermined imaging range;
a process of generating a reference image based on design information of the object to be inspected; and
a process of inspecting the inspection target area by comparing the inspection image with the reference image,
wherein, in the process of generating the reference image, by using the positional data, different reference images are generated for areas that show a common structure in the design information.

2. The image processing method according to claim 1, wherein, in the process of generating the reference image, the reference image is generated by inputting, to a machine learning model that is learned in advance, a design image which is based on the design information and the positional data regarding the inspection image.

3. The image processing method according to claim 2, wherein the machine learning model is a model that is learned using learning data, which is a set of a learning image included in an image obtained by imaging a learning sample by the detector having the predetermined imaging range, a sample design image, which is an image of the learning sample drawn in accordance with design information of the learning sample, and positional data indicating an imaging position, which is a position of the learning image in the predetermined imaging range.

4. The image processing method according to claim 1, wherein
in the process of generating the reference image,
a design image which is based on the design information is corrected, by an optical simulation that uses the positional data regarding the inspection image, to a design image on which the positional data is reflected, and
the reference image is generated by inputting the corrected design image to a machine learning model that is learned in advance.

5. The image processing method according to claim 4, wherein the machine learning model is a model that is learned using learning data, which is a set of a learning image included in an image obtained by imaging a learning sample by the detector having the predetermined imaging range, and a sample design image, which is an image of the learning sample drawn in accordance with design information of the learning sample.

6. The image processing method according to claim 1, wherein, in the process of generating the reference image, the reference image is generated by inputting a design image which is based on the design information to one of a plurality of machine learning models learned in advance that has been selected based on the positional data regarding the inspection image.

7. The image processing method according to claim 6, wherein
each of the plurality of machine learning models is a model that is learned by using learning data, which is a set of a learning image included in an image obtained by imaging a learning sample by the detector having the predetermined imaging range and a sample design image which is based on design information of the learning sample, and
in the learning data used for learning, a section to which an imaging position, which is a position of the learning image in the predetermined imaging range, belongs is different for each of the machine learning models.

8. The image processing method according to claim 1, wherein
a target to be imaged by the detector is illuminated by critical illumination,
the detector is a TDI sensor that has image pickup elements arranged in a first direction and a second direction and accumulates electrical charges from the plurality of respective image pickup elements arranged in the second direction, and
the positional data indicates an imaging position of the inspection image in the first direction.

9. The image processing method according to claim 1, wherein
a positional image, which is a partial image cut out of a gradation image whose width is the same as that of the image captured by the detector, is used as the positional data, and
a relative position of the positional image with respect to the gradation image corresponds to the imaging position of the inspection image.

10. The image processing method according to claim 9, wherein
the detector is a TDI sensor that has image pickup elements arranged in a first direction and a second direction and accumulates electrical charges from the plurality of respective image pickup elements arranged in the second direction, and
the gradation image is an image with gradation in the first direction.

11. The image processing method according to claim 1, wherein
a subsequence of a strictly monotonically increasing sequence of numbers or strictly monotonically decreasing sequence of numbers is used as the positional data, and
a relative position of the subsequence with respect to the sequence of numbers corresponds to the imaging position of the inspection image.

12. The image processing method according to claim 1, wherein
a subsequence of a weakly monotonically increasing sequence of numbers or weakly monotonically decreasing sequence of numbers is used as the positional data,
the sequence of numbers successively includes a constant value at a center of the sequence of numbers, and
a relative position of the subsequence with respect to the sequence of numbers corresponds to the imaging position of the inspection image.

13. An image processing apparatus comprising:
at least one memory storing instructions; and
at least one processor configured to execute the instructions to:
acquire an inspection image, which is an image obtained by imaging an inspection target area of an object to be inspected, the inspection image being included in an image obtained by imaging, by a detector having a predetermined imaging range, the object to be inspected;
acquire positional data indicating an imaging position, which is a position of the inspection image, in the predetermined imaging range;
generate a reference image based on design information of the object to be inspected; and
inspect the inspection target area by comparing the inspection image with the reference image,
wherein, in generating the reference image, different reference images are generated for areas that show a common structure in the design information by using the positional data.

14. The image processing apparatus according to claim 13, wherein the processor is configured to execute the instructions to generate the reference image by inputting, to a machine learning model that is learned in advance, a design image which is based on the design information and the positional data regarding the inspection image.

15. The image processing apparatus according to claim 14, wherein the machine learning model is a model that is learned using learning data, which is a set of a learning image included in an image obtained by imaging a learning sample by the detector having the predetermined imaging range, a sample design image, which is an image of the learning sample drawn in accordance with design information of the learning sample, and positional data indicating an imaging position, which is a position of the learning image in the predetermined imaging range.

16. The image processing apparatus according to claim 13, wherein the processor is configured to execute the instructions to:
correct, by an optical simulation that uses the positional data regarding the inspection image, a design image which is based on the design information to a design image on which the positional data is reflected; and
generate the reference image by inputting the corrected design image to a machine learning model that is learned in advance.

17. The image processing apparatus according to claim 13, wherein
a target to be imaged by the detector is illuminated by critical illumination,
the detector is a TDI sensor that has image pickup elements arranged in a first direction and a second direction and accumulates electrical charges from the plurality of respective image pickup elements arranged in the second direction, and
the positional data indicates an imaging position of the inspection image in the first direction.

18. The image processing apparatus according to claim 13, wherein
a positional image, which is a partial image cut out of a gradation image whose width is the same as that of the image captured by the detector, is used as the positional data, and
a relative position of the positional image with respect to the gradation image corresponds to the imaging position of the inspection image.

19. The image processing apparatus according to claim 18, wherein
the detector is a TDI sensor that has image pickup elements arranged in a first direction and a second direction and accumulates electrical charges from the plurality of respective image pickup elements arranged in the second direction, and
the gradation image is an image with gradation in the first direction.

20. A learning method comprising:
a process of acquiring learning data, which is a set of a learning image included in an image obtained by imaging a learning sample by a detector having a predetermined imaging range, a sample design image which is based on design information of the learning sample, and positional data indicating an imaging position, which is a position of the learning image in the predetermined imaging range; and
a process of generating a machine learning model that receives a target design image and positional data indicating an imaging position, which is a position of an inspection image in the predetermined imaging range, as input and outputs a reference image by performing machine learning by using the learning data, wherein
the target design image is an image of an inspection target area of an object to be inspected drawn in accordance with design information of an object to be inspected,
the inspection image is an image obtained by imaging the inspection target area of the object to be inspected, the inspection image being included in an image obtained by imaging, by the detector, the object to be inspected, and
the reference image is an image that is compared with the inspection image in order to inspect the inspection target area.
